(19) United States
(12) Patent Application Publication
(10) Pub. No.: US 2004/0032860 A1
(43) Pub. Date: Feb. 19, 2004

(54) Quality of voice calls through voice over IP gateways

(76) Inventors: Satish Mundra, Germantown, MD (US); Carlos Eduardo Hernandez, Maracaibo (VE)

Correspondence Address: Warren Franz, Texas Instruments Incorporated, MS 3999, P.O. Box 655474, Dallas, TX, 75265, US

(21) Appl. No.: 10/222,633

(22) Filed: Aug. 19, 2002

(51) Int. Cl. H04L 12/66; H04L 12/28

(52) U.S. Cl. 370/352; 370/401

(57) ABSTRACT

A technique to change a codec in realtime during transmission of a voice over packet call placed over a packet switched network, such as the Internet, is described. The invention provides users real-time control over the cost and quality of a voice over packet call by monitoring the dynamically changing resources and network conditions on a packet network and allowing users to change codecs of the call transmission before and during the call according to user-defined specifications.

### CROSS-REFERENCE TO RELATED APPLICATIONS

None

### FIELD OF THE INVENTION

The present invention relates to improving the cost-efficiency and quality of speech transmissions over packet networks, such voice over Internet Protocol (VoIP).

### BACKGROUND OF THE INVENTION

Organizations around the world want to reduce rising communications costs. The consolidation of separate voice and data networks offers an opportunity for significant cost savings. Organizations are pursuing solutions which will enable them to take advantage of excess capacity on data networks for voice and data transmission, as well as utilizing the Internet and company Intranets as alternatives to costlier traditional mediums A Voice over Packet (VOP) application can combine legacy voice networks and packet networks by allowing both voice and signaling information to be transported over the packet network. VOP applications require real-time software and hardware modules that can be dynamically configured to provide flexibility and scalability in communication systems with well defined Application Programming Interfaces (APIs). Because of cost savings and other advantages such as accessibility of a large number of users, VOP typically runs over the Internet or a privately managed national or international network.

Digitization and transmission of voice first occurred in the 1950s with the advent and use of solid state electronics. The first commercial usage of a digitized voice carrier was in 1962 when Bell System installed and operated a T1 carrier system for use as a trunk group in the Chicago exchange. Digital speech encoding converts speech into digital forms suitable for transmission on a digital network and decoding reverses the process at the receiving end of the network. Two primary techniques are waveform coding and vocoding. Waveform coders are found in traditional voice networks and ATM and are primarily encoding/decoding algorithms mainly performing input waveform reproduction as accurately as possible with little or no knowledge of the type of signal being processed Vocoders (voice coders) specifically encode/decode speech signals only. Vocoders encode the perceptually important aspects of speech while using less bits than waveform coders. Therefore, vocoders can be used in networks where less bandwidth is available for voice transmissions. Devices that perform speech digitization are called “codecs”, for coder/decoder. A network with sending and receiving coders include an analog-to-digital (A/D) convertor to ditigize speech, an analysis module to prepare the digitized speech for transmission, synthesis modules to decode a received digitized transmission, and a digital-to-analog (D/A) convertor to change the signal from digital back to analog speech for playout to the human ear. Pulse code modulation (PCM) is currently the most popular application for digitizing speech. Examples of various encoders include logarithmic PCM, adaptive delta modulation, subband coder, adaptive differential PCM (ADPCM), adaptive predictive, channel vocoder, linear predictive coding, and formant vocoder. In the mid-1990s the ITU-T standardizes vocoders that are applicable to VoIP applications A sample of ITU-T speech coding standards are G.711 (64 kbps PCM with A-law and u-law), G.722 (64, 56, or 48 kbps wideband vocoder), G.726 (ADPCM vocoder), G.727 (40, 32, 24, or 16 kbps Embedded ADPCM), G.728 (16 kbps low delay code excited linear prediction vocoder), G.729 (8 kbps conjugate structure algebraic code excited linear prediction (CS-ACELP)), G.723.1 (5.3, 6.3 kbps multi-rate encoder for multimedia communications).

Many manufactured products for transmitting voice and video were based on proprietary methods that limit interoperability. In an attempt to standardize voice, video, and data communications over the Internet, the ITU-T H.323 was drafted to standardize terminals, equipment, and services for multimedia transmissions over LANs and IP networks which do not have guaranteed QoS H.323 uses standards G.711, G 722, G.278, G.729, and G.723 audio and speech codex as part of the multimedia standard. Coder/decoder systems attempt to reduce the datarate and are therefore lossy, which lowers the quality of the transmission.

The goal of any voice codec and transmission process obviously is a faithful reproduction of the original speech. The optimal speech quality is “toll quality” or the quality of a call made over the traditional public switched telephone network (PSTN). Quality of voice transmission is compromised by the quantization process, noise, or quality of service (QoS) problems in an IP network such as packet transmission delay and jitter. Quantization is the process of mapping amplitudes of analog speech into discrete digital values which results in a loss of information. Quality is impacted by both the codec and compression methods together with QoS of the Internet. Delay in signals causes two problems, echo and talker overlap. Echo is caused by the signal reflections of the speaker's voice from the far end telephone equipment back into the speaker's ear. Talker overlap becomes significant if the one way delay becomes greater than 250 ms. Accumulation delay, or algorithmic delay, is cause by the need to collect a frame of voice samples to be processed by the voice coder. Processing delay is caused by the actual process of encoding and collecting the encoded samples into a packet for transmission over the packet network. Network congestion on the Internet negatively affects quality of service for voice transmissions, as well as the ability of switches to perform real-time IP switching. Network delay is caused by the physical medium and protocols used to transmit the voice data, and by the buffers used to remove packet jitter on the receive side. Jitter is a variable inter-packet timing caused by the network a packet traverses. Removing jitter requires collecting packets and holding them long enough to allow th slowest packets to arrive in time to be played in the correct sequence. Lost packets is an even more severe problem, depending on the type of packet network that is being used. Because IP networks do not guarantee service, they will usually exhibit a much higher incidence of lost voice packets than ATM networks.

Broadband access devices such as cable modems or digital subscriber line (DSL) modems are increasingly expected to provide IP telephony services in addition to high-speed data. They are typically expected to have two or more RJ11 ports for telephony services that would accommodate either two telephone extensions or a telephone and fax machine. For the end user, the telephony/data ports are expected to look and act similar to a standard analog telephone line for use in making local and long-distance telephone calls as well as for sending fax transmissions.

When placing a VoIP call, there is typically an original VOP codec limitation that is negotiated at the beginning of the call and cannot be changed during the transmission. Both ends of a VoIP call must use the same codec. Codecs can either be manually selected by users through specialized software, or a default codec may be used in a VoIP managed network that is out of control of the end user. One codec may not be ideal for all telephony devices and network conditions. For example, changing network conditions such as packet propagation delays may cause a sudden need for greater processing power and bandwidth during a call. A user on a VoIP call may simply desire to decrease the quality of a call to save costs or to increase quality for clearer speech transmissions during a call. Changing the codec based upon the user's intentions while a call is in progress would include the option to change the codec in realtime.

### SUMMARY

During a voice over packet call, the choice of codec used for initially establishing the call depends upon the codecs that are supported at sending and the receiving telephony devices. Both the sending and receiving devices must use the same codecs during speech transmissions to take advantage of the lower transmission rates and higher quality transmissions offered by specialized codecs for speech over packet networks. Users of an IP telephony system may subscribe to a service where lowering the cost of the voice call is the default policy, and therefore the lowest cost codec is present for the users.

However, after placing a call and speech is being transmitted, a user at one end may desire a higher quality call through either a better network managed network connection or a better codec, which may not correspond to the lowest cost transmission. Support for such a change in codec is generally absent from signaling protocols, such as media gateway control protocol (MGCP), except for the case when a switch over to basic PCM is desired when the call is being established and the call is formatted for modem or facsimile transmissions.

Other dynamic network constraints on the choice of codec include available bandwidth, available processing power, and other network interference conditions such as delay, loss, and jitter. The dynamic constraints in the network may change during the course of call transmissions. For example, a conversation may begin on a high-quality bandwidth connection that has little delay and few lost packets, but as the call progresses, the call quality degrades significantly due to network traffic causing delay, echo, lost packets, or other propagation problems. Significant benefits in terms of cost or quality are derived if a user has the ability to change a codec at will during a call transmission depending on changes in either network conditions, cost considerations, or desired call quality.

### BRIEF DESCRIPTION OF THE DRAWINGS

Preferred embodiments of the invention are discussed hereinafter in reference to the drawings, in which:

FIG. 1 is a diagram of a typical of a voice over packet broadband network configuration;

FIG. 2 is a diagram of a voice over packet broadband network configuration having a call agent module;

FIG. 3 is a diagram of a voice over packet broadband network configuration using the PSTN.

### DETAILED DESCRIPTION OF THE INVENTION

There is described herein a technique to lower the cost and improve the quality of voice calls over IP networks by providing users the ability to select an appropriate codec during a voice over IP call. The invention gives users real-time control over the cost and quality of the voice call by monitoring the dynamically changing resources and network conditions on an IP network and allowing users to select appropriate codecs before and during the call.

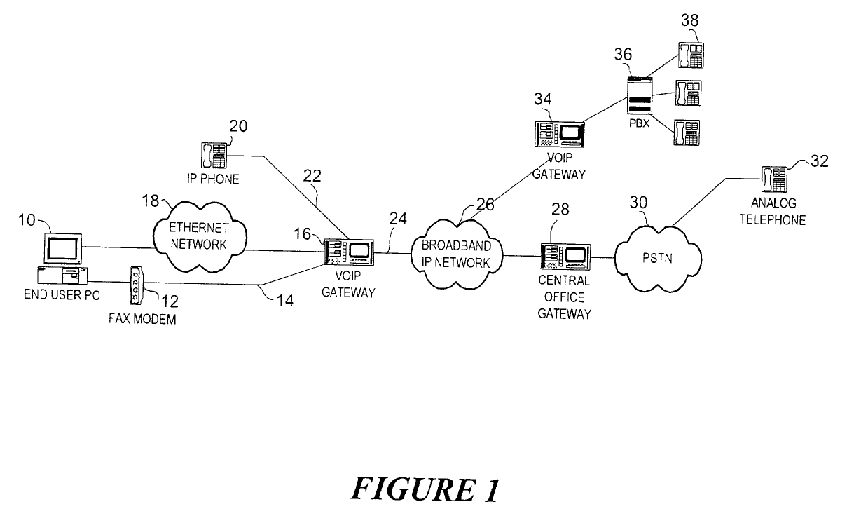

A typical voice over IP (VoIP) broadband network is illustrated in FIG. 1. An end user at a personal computer 10 can access a gateway 16 connected to a broadband network 26 with a fax modem 12 via an RJ11 telephony port 14. The gateway 16 connects to the broadband network with a high speed Internet connection 24 such as a digital subscriber line (DSL), cable modem 24, or T1/T5 line The PC 10 is connected to (gateway 16 with a network connection such as Ethernet 18 Gateway 16 has two telephony ports, one for voice and one for fax. A digital VoIP telephone 20 may also connect to gateway 16 through telephony port 22. The broadband network 26 can also include the public Internet as part of the broadband network 26.

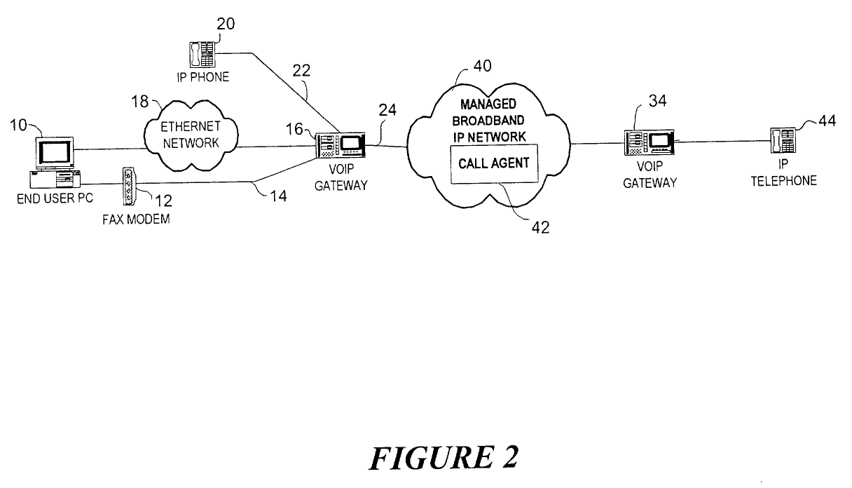

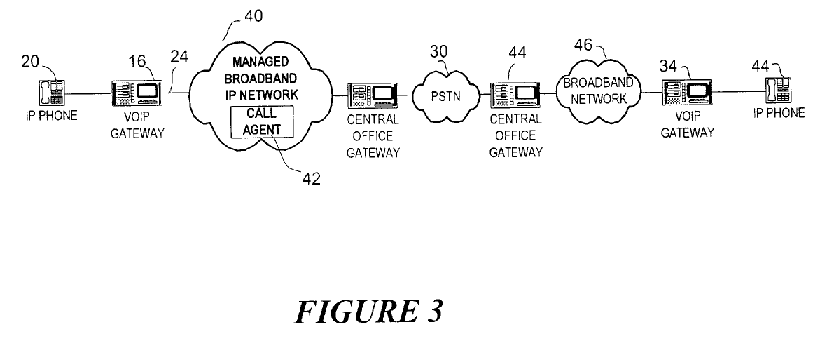

FIG. 2 illustrates a diagram of a broadband IP network connecting two VoIP telephony devices is illustrated. IP network is a managed broadband network. As part of the managed network, an network provider could utilize bandwidth on the public Internet 30 as a seamless connection between two ISP-managed networks 42, 46, as illustrated in FIG. 3.

Referring again to FIG. 2, the system includes a managed network 40 between a first IP telephony device 20 on one end and a second IP telephony device 44, such an IP phone, on the second end. Gateways 16, 34 support voice over packet calls and monitors network conditions within managed network 40 Gateway 16 sends and receives messages from a call agent module 42 that is managed by the network managing entity Gateway 16 must be capable of detecting changing resource or network conditions. The ability to detect and monitor changing resource and network conditions can result in significant cost reductions and/or improved quality.

A user may subscribe to an Internet telephony service where lowering the cost is the default policy at both gateways and IP telephony network provider. A user may also desire a higher quality, or lower quality, codec during transmission for reasons unrelated to call quality or cost. The desired codec may or may not be the codec of lowest cost Dynamic codec changes are supported within gateways and call control protocols Gateway 16 receives such user commands and takes appropriate action by signaling agent 42 in the managed network 40 to effect a change in the codec. Call agent module 42 is managed by the network provider to receive commands from IP phone 20 or gateway 16 and the change the codecs in realtime during a call transmission. Monitored network events and user commands are received by gateway 16, which then sends commands and call control protocols to call controller agent 42 to cause a codec change. A user-specified change in codec is made according to user-defined criteria including cost and call quality based on the network conditions as monitored by gateway during the call. An alternative to enabling the present invention by call control protocols is to add a vendor's extension to an existing telephony system.

Broadband gateways 16 monitor and detect events affecting a VoIP call, including processing power, delay, and jitter. Gateway 16 monitors the availability of processing power and determines if a lower bit rate codec could be supported. The gateway 16 could use a lookup table which provides maximum instances, both symmetric and asymmetric, of a particular codec supported by the gateway under various combinations of network conditions.

The gateway monitors bandwidth for all calls terminating at gateway 16 and will detect packet loss resulting from congestion. Packet loss in the media stream could signal network congestion and may result in selection of a low bit rate codec for affected calls or interchange the codec with another call that may not be experiencing such losses The availability of greater bandwidth could also result in changing to a high bit rate codec, if so desired by the user. The packet size, or VIF, VAD (voice activity detection) can be changed, enabled, or disabled to improve quality or reduce costs of the call. Packet loss bandwidth resource reservation authority may be queried for detecting bandwidth availability, or a dummy reservation may be attempted to secure available bandwidth Real-time control protocol (RTCP) could also be used to monitor network conditions and generate this event.

Network delay and jitter degrade the voice quality of a call, and difference codecs can cause different levels of degradation for a particular value of delay, jitter, VIF size, and voice activity detection (VAD). Monitoring jitter and packet loss in a network can be achieved by monitoring the media stream such as using RTCP. Gateway 16 detects network conditions affecting the call quality, and if a codec change is feasible to improve quality, signals an event to the agent module to prepare both gateways for a potential change in codec. A user could define protocols to automatically have agent change the codec, such as lowest cost, highest quality, or highest bandwidth. The improved quality could result in additional costs, however the change is controlled by the user and conditionally generated only upon the user's command.

As an additional consideration in detecting network events, if network monitoring events and monitoring by gateway 16 are supported by call control protocol, the codecs could be used asymmetrically if the resource constraints do not support full duplex. The processing requirement for some codec for encode and decode operations are orders of magnitude apart and half duplex use would also result in benefits identified herein.

A user could normally subscribe to a policy from a network provider where lowering the cost could be the prime concern. In such case the call agent would request additional events, thereby effecting the use of a low-cost codec whenever feasible. A user may have a call wherein a higher quality transmission is desired, regardless of the cost considerations. For example, a user may desire a higher quality and higher cost call when speaking to a client or customer, but would settle for a lower-quality and lower cost call when making personal calls. Before or during call transmission, commands are sent from pre-assigned keys on a dialpad or directly from an end user PC to the gateway and agent which switches event detection to enable the best, lowest, or midrange codec, according to the category of classification the user desires, such as highest quality or lowest cost.

Monitoring and detecting the resource availability and network condition at media gateways could result in improved performance and lower the cost. This would put the cost and quality decision within control of the user and optimal output according to the user's commands could be derived.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed is:

1. A method for voice over packet telephony, comprising:
establishing a voice call on a packet network between a first user and a second user wherein the call is transmitted using a first codec,
monitoring conditions in the network with a first and a second gateway that are connected to the packet network and support the voice call;
communicating call control protocols between a call agent and the first and second gateways;
sending a command to the call agent to change the first codec to a second codec;
changing the first codec to the second codec in realtime during transmission of the voice call.

2. The method of claim 1, wherein:
the step of sending a command to the call agent comprises using a telephony device to send commands to one of the gateways; and
the gateways receiving the command determines if the command execution is feasible according to the network conditions.

3. The method of claim 1, wherein.
each of the first and second gateways are pre-programmed to automatically change to the second codec according to user-defined call protocols

4. The method of claim 1, wherein
the step of monitoring conditions in the network includes using a lookup table to provide maximum instances of a codec that is supported by the first and second gateways according to the monitored network conditions.

5. A system for voice over packet telephony, comprising:
a first gateway establishing a voice over packet call with a second gateway over a packet network between a first user and a second user;
wherein each first and second gateway supports voice over packet protocols and monitors network conditions in the packet network; and
a call protocol agent that receives commands from each gateway and from each user, wherein the call agent changes a first codec to a second codec in realtime during transmission of the call.

6. The system of claim 5, wherein:
the first and second gateways monitor conditions in the packet network to provide maximum instances of a codec that is supported by the first and second gateways according to the monitored network conditions.

7. The system of claim 5, wherein:
the call protocol agent receives commands to change codecs from a telephony device operated by the user.

8. The system of claim 5, wherein:
the call agent automatically changes from the first codes to the second codec according to user-defined protocols determined prior to placing the voice call
